(19) United States
(12) Patent Application Publication
(10) Pub. No.: US 2010/0107182 A1
(43) Pub. Date: Apr. 29, 2010

(54) Class system handler for quality of service in extended computer systems

(76) Inventor: David A. Daniel, Scottsdale, AZ (US)

Correspondence Address: Law Office of ROBERT C. KLINGER, 2591 Dallas Parkway, Suite 300, FRISCO, TX, 75034, US

(21) Appl. No.: 12/587,788

(22) Filed: Oct. 13, 2009

Related U.S. Application Data
(60) Provisional application No. 61/195,852, filed on Oct. 10, 2008.

(51) Int. Cl. G06F 9/44

(52) U.S. Cl. 719/327

(57) ABSTRACT

A solution for handling Quality of Service (QOS) application compatibility in extended computer systems via a class system. The invention utilizes a framework based on definition of classes for performance categorization and management of application compatibility and user experience.

### CLAIM OF PRIORITY

This application claims priority of U.S. Provisional Patent Application Ser. No. 61/195,852 entitled “A CLASS SYSTEM HANDLER FOR QUALITY OF SERVICE IN EXTENDED COMPUTER SYSTEMS” filed Oct. 10, 2008, the teachings of which are incorporated herein by reference.

### FIELD OF THE INVENTION

The present invention relates to extension of a computer's native system bus via high speed data networking protocols and the quality of service in such a system.

### BACKGROUND OF THE INVENTION

There is growing acceptance of techniques that leverage networked connectivity for extending and centralizing the resources of host computer systems. In particular, networked connectivity is being widely utilized for specialized applications such as attaching storage to computers. iSCSI makes use of TCP/IP as a transport for the SCSI parallel bus to enable low cost remote centralization of storage. The problem with iSCSI is it has a relatively narrow (storage) focus and capability.

Another trend is the move towards definition and virtualization of multiple computing machines within one host system. Virtualization is particularly well suited for blade server installations where the architecture is optimized for high density compute resources and pooled storage. The virtualization of CPU cycles, memory resources, storage, and network bandwidth allows for unprecedented mobility, flexibility, and adaptability of computing tasks.

PCI Express, as the successor to PCI bus, has moved to the forefront as the predominant local host bus for computer system motherboard architectures. A cabled version of PCI Express allows for high performance directly attached bus expansion via docks or expansion chassis. These docks and expansion chassis may be populated with any of the myriad of widely available PCI Express or PCI/PCI-X bus adapter cards. The adapter cards may be storage oriented (i.e. Fibre Channel, SCSI), video processing, audio processing, or any number of application specific Input/Output (I/O) functions. A limitation of PCI Express is that it is limited to direct attach expansion. A problem with certain blade server architectures is PCI Express is not easily accessible, thus expansion is awkward, difficult, or costly.

Gbps Ethernet is beginning to give way to 10 Gbps Ethernet. This significant increase in bandwidth enables unprecedented high performance applications via networks.

A hardware/software system and method that collectively enables virtualization of the host bus computer's native I/O system architecture via the Internet, LANs, WANs, and WPANs is described in commonly assigned U.S. patent application Ser. No. 12/148,712, the teachings of which are incorporated herein by reference. The system described, designated “i-PCI” achieves technical advantages as a hardware/software system and method that collectively enables virtualization of the host computer's native I/O system architecture via the Internet, LANs, WANs, and WPANs. The system includes a solution to the problems of the relatively narrow focus of iSCSI, the direct connect limitation of PCI Express, and the inaccessibility of PCI Express for expansion in blade architectures.

With reference to FIG. 1 at 10, this system allows devices native to the host computer native I/O system architecture—including bridges, I/O controllers, and a large variety of general purpose and specialty I/O cards—to be located remotely from the host computer, yet appear to the host system and host system software as native system memory or I/O address mapped resources. The end result is a host computer system with unprecedented reach and flexibility through utilization of LANs, WANs, WPANs and the Internet.

A problem with virtualization and extended computer systems is there is additional latency not seen in unextended systems. Native I/O systems such as PCI Express can be classified as a high bandwidth, low overhead, low latency interconnect. In order for the Internet and LANs to serve as a viable transport, extended computer systems must retain or mitigate these basic performance characteristics.

Internet and LANs based on 10 G Ethernet provide the raw bandwidth necessary to preserve the high bandwidth characteristic for native I/O systems such as PCI Express. With the basic bandwidth requirements addressed, the low overhead and low latency characteristics remain the primary performance challenges for extended computer systems.

A goal of extended systems is application software, operating system, and I/O driver transparency. Although this goal is relatively straight forward, it does not mean that Quality of Service (QOS) is expected to be or has to be identical to the default native non-extended computer system implementation. For example, this is the case with iSCSI storage QOS when comparing to Parallel SCSI QOS. Thus, it is logical to expect that the results would be similar with extended computer systems, in general. In the majority of applications, it is expected there will be some notable QOS difference when comparing the extended computer system implementation to the default non-extended computer system implementation. Latency quickly surfaces as a problem for certain applications. Given this obvious downside, what is needed is a solution to allow the development of extended computer systems, despite the QOS impact.

A situation analogous to the one described here occurred with the advent of IP telephony. The concept of voice communications over the Internet was initially viewed by some in industry as an incompatible application. It was thought that the lack of deterministic behavior associated with the Internet would prevent it from being a viable transport for voice communications. The general public was used to the relatively high QOS associated with the traditional PSTN switched circuit implementation and it was thought that there would be little acceptance of the lower QOS inherent with voice over Internet. However, what skeptics failed to account for was the fact that the public would trade off QOS if it meant they would have some significant advantage in return. In the case of voice over the Internet, it was the advantage of extending their reach to anyone anywhere in the world for relatively low cost.

The same factors that were in play for IP telephony are again in play, this time the area of virtualization and extended computer systems. In the case of i-PCI, there is the tradeoff of the relatively high QOS associated with PCI Express and the thinking that the QOS must be adhered to. The thought is that just as with PSTN vs. Voice-Over-IP, it is possible to trade off QOS to achieve some advantage. In the case of i-PCI the advantage is that of a host computer system with unprecedented reach and flexibility.

### SUMMARY OF THE INVENTION

The invention achieves technical advantages as a solution for the negative impact to QOS in extended computer systems. One aspect of the invention comprises a system and methodology whereby QOS may be classified such that application performance is predictable and manageable. A software-based system handler may be implemented to manage the QOS issues.

The invention is a solution for handling QOS application compatibility in extended computer systems via a class system. The invention utilizes a framework based on definition of classes for performance categorization and management of application compatibility. The net result is a solution that characterizes and manages this QOS or performance difference.

### BRIEF DESCRIPTION OF THE DRAWINGS

FIG. 1 depicts using the Internet as a means for extending a computer system's native bus via high speed networking;

FIG. 2 depicts one embodiment of the Class System Handler implemented in kernel space sing a Class Table; and

FIG. 3 depicts one preferred embodiment of the Class Table.

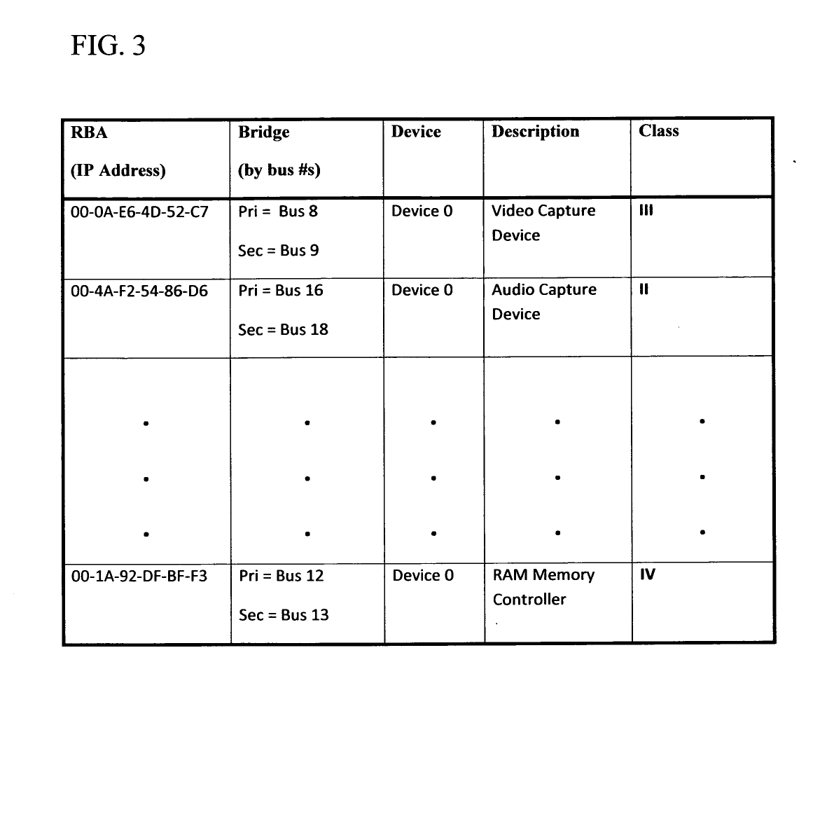

### DETAILED DESCRIPTION OF THE PRESENT INVENTION

One aspect of the invention is a solution to characterize and manage QOS or performance variations in virtualized or extended systems, so end results are predictable.

A class system is defined that categorizes this relative QOS difference. The class system advantageously helps avoid the tendency to categorize an application as “it works in extended computer systems or it doesn't work” in extended computer systems, or, that it “works, but . . . just sort of”. This class system approach provides a universal framework for software development and evaluation of the suitability or compatibility of an application in the extended computer system.

With this background in mind, the class system is defined for extended systems. One preferred embodiment is a class system defined as follows:

Class I: Class I performance: There is no measurable difference, at the application level, when comparing the performance in a given extended computer system implementation to the default native non-extended computer system implementation on the same host system.

Class II: Class II performance: There is a measurable difference, at the application level, when comparing the performance in a given extended computer system implementation to the default native non-extended computer system implementation on the same host system. However, the application runs within an acceptable performance range as specified by the supplier.

Class III: Class III performance: There is a significant measurable difference, at the application level, when comparing the performance in a given extended computer system implementation to the default non-extended computer system implementation on the same host system. The application runs without error, but with limited or reduced capability and effectiveness.

Class IV: Class IV performance: There is a major measurable difference, at the application level, when comparing the performance in a given extended computer system implementation to the default non-extended computer system implementation on the same host system. The application loads and runs, but is prone to occasional errors or unexpected termination.

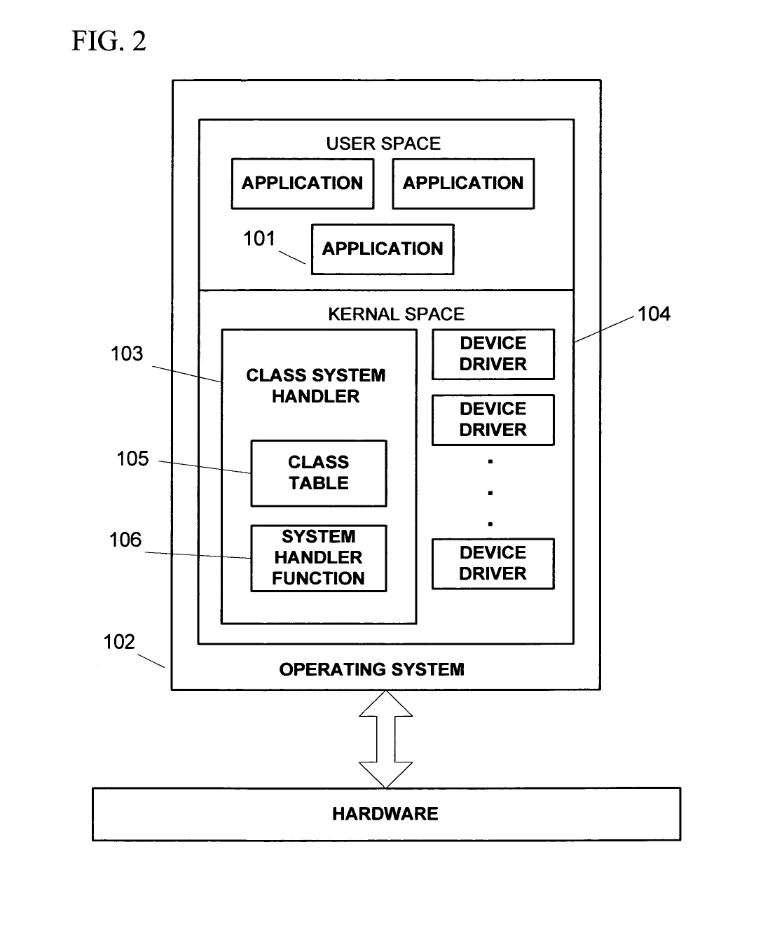

Referring to FIG. 2, the class system 100 may be used simply as a reference to describe user expectations for an application in a given installation. However, the class system 100 can also be used as a reference in a module or mechanism to universally tailor how each given application 101 and/or Operating System 102 responds to QOS-generated errors, timeouts, and retries. This invention is referred to herein as a Class System Handler (CSH). The CSH is preferably, but not necessarily, located in kernel space 103 and consists of a Class Table 104, and optionally, a system handler function 105. The Class Table is readily accessible to any device driver.

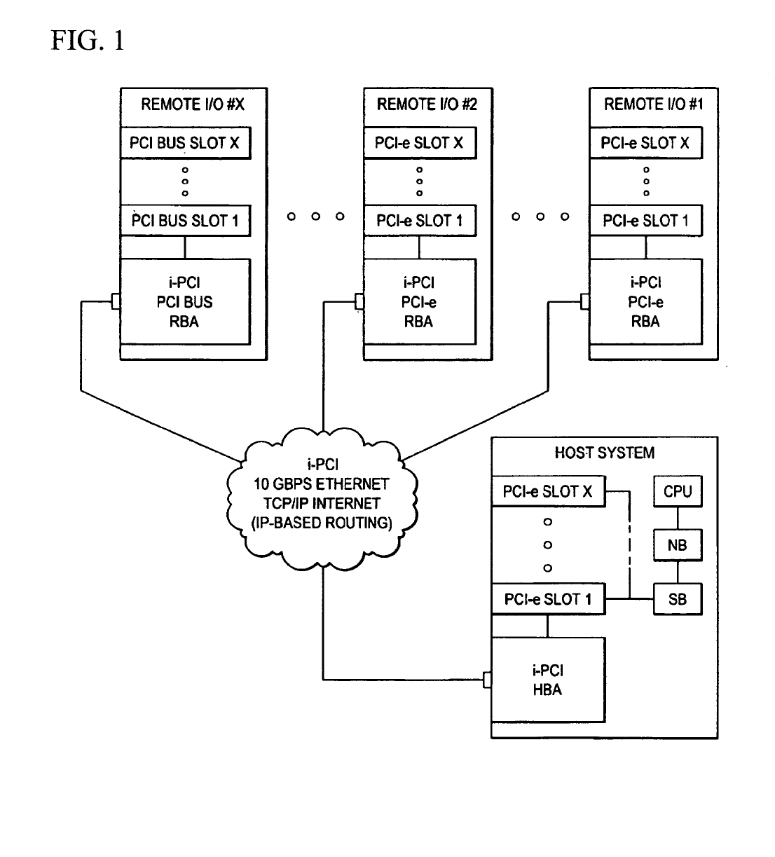

For example, if a device 11, such as in extended system 10 as shown in FIG. 1, is located remotely from the host computer system 12 and is characterized and/or determined to be functioning at the Class IV level, the user stores the class information associated with the device in the Class Table 105. Alternately, the software-based class system handler function may dynamically determine the class for a given device automatically by monitoring data traffic through the kernel, or via automatic testing, and populate the Table 105 without direct user input. Once the Table 105 is populated, a “Class Table aware” application and a “Class Table aware” device driver may then optimize their behavior and access to the target device 11 (i.e. timing, data generation, and error generation). This optimization is based on the class entry associated with the particular device 11. The class entry provides relative and critical insight into the fact that the target device 11 is part of the extended computer system 10 and located remotely from host system 10 and other target devices 11. The net result of the optimization is each target device 11 may now be able to function at an improved level, i.e. Class III or even Class II, and the user has a much improved experience.

Though the invention has been described with respect to a specific preferred embodiment, many variations and modifications will become apparent to those skilled in the art upon reading the present application. The intention is therefore that the appended claims be interpreted as broadly as possible in view of the prior art to include all such variations and modifications.

What is claimed is:

1. A module configured to characterize and manage QOS or performance variations of a remote target device in a virtualized or extended computer system having a host computer.

2. The module as specified in claim 1 where the module is configured to be located in a kernel space of the host computer in the computer system.

3. The module as specified in claim 1 where the module further includes a table configured to store relative performance classifications indicative of the characterized QOS or performance variations of a plurality of said remote target devices.

4. The module as specified in claim 1 wherein the performance classifications of the remote target devices are dynamically determined by the host computer during operation of the computer system.

5. The module as specified in claim 3 wherein each of the performance classifications are a function of actual operability of the associated said remote target device in relation to the host computer in the computer system.

6. The module as specified in claim 3 wherein the host computer system includes at least one device driver configured to improve its behavior and its access to the remote target device based on the associated performance classification of the remote target device.

7. The module as specified in claim 6 wherein the associated performance classification is a function a performance range of the remote target device with respect to the host computer.

8. The module as specified in claim 7 wherein the associated performance classification is a function of an error rate of the remote target device with respect to the host computer.

9. The module as specified in claim 1 wherein the module is configured to improve the operability of an application in the host computer system with the remote target device.

10. The module as specified in claim 3 wherein the module is configured to improve the operability of an application in the host computer system with the remote target device as a function of the classification of the remote target device.

11. A computer readable medium including instructions configured to characterize and manage QOS or performance variations of a remote target device in a virtualized or extended computer system having a host computer.

12. The computer readable medium as specified in claim 11 where the instructions are configured to be located in a kernel space of the host computer in the computer system.

13. The computer readable medium as specified in claim 11 where the instructions further include a table configured to store relative performance classifications indicative of the characterized QOS or performance variations of a plurality of said remote target devices.

14. The computer readable medium as specified in claim 11 wherein the performance classifications of the remote target devices are dynamically determined by the host computer during operation of the computer system.

15. The computer readable medium as specified in claim 13 wherein each of the performance classifications are a function of actual operability of the associated said remote target device in relation to the host computer in the computer system.

16. The computer readable medium as specified in claim 13 wherein the host computer system includes at least one device driver configured to improve its behavior and its access to the remote target device based on the associated performance classification of the remote target device.

17. The computer readable medium as specified in claim 16 wherein the associated performance classification is a function a performance range of the remote target device with respect to the host computer.

18. The computer readable medium as specified in claim 17 wherein the associated performance classification is a function of an error rate of the remote target device with respect to the host computer.

19. The computer readable medium as specified in claim 11 wherein the instructions are configured to improve the operability of an application in the host computer system with the remote target device.

20. The computer readable medium as specified in claim 13 wherein the instructions are configured to improve the operability of an application in the host computer system with the remote target device as a function of the classification of the remote target device.
